(19) United States
(12) Patent Application Publication
(10) Pub. No.: US 2007/0184226 A1
(43) Pub. Date: Aug. 9, 2007

(54) Flexible hose

(76) Inventor: Michael D. Winzeler, Bryan, OH (US)

Correspondence Address: FRASER CLEMENS MARTIN & MILLER LLC, 28366 KENSINGTON LANE, PERRYSBURG, OH, 43551, US

(21) Appl. No.: 11/346,685

(22) Filed: Feb. 3, 2006

(51) Int. Cl. B32B 1/08

(52) U.S. Cl. 428/36.1

(57) ABSTRACT

A flexible hose comprises a non-woven spun bonded fibrous polyolefm tube, and a layer of a liquid impervious polymer adhered to a major surface thereof.

### FIELD OF THE INVENTION

The present invention is directed to a flexible hose, and a method for manufacturing same. More particularly, the invention is direct to a highly flexible, liquid impervious fluid conduit made in part from a reinforced material, and to a method for manufacturing said fluid conduit.

### BACKGROUND OF THE INVENTION

The prior art hoses which employ a filament-reinforced material are disclosed as useful for irrigation purposes. This is because the filament-reinforced materials used are fluid permeable. Thus, when the hose is pressurized with water, water permeates through the interstices between the filaments of the material.

For example, U.S. Pat. No. 3,996,968 to Bergman et al. discloses tubing articles fabricated from non-woven spun bonded fibrous polyolefin web materials which are useful as agricultural soaker hoses.

It would be desirable to prepare a highly flexible, liquid impervious hose which uses a filament-reinforced material to impart light weight and dimensional stability.

### SUMMARY OF THE INVENTION

Accordant with the present invention, there surprisingly has been discovered a highly flexible, liquid impervious hose which exhibits light weight and dimensional stability, comprising:
a non-woven spun bonded fibrous polyolefin tube; and
a layer of a liquid impervious polymer adhered to a major surface of the tube.

Also contemplated by the present invention is a process for preparing a highly flexible, liquid impervious hose.

The flexible hose according to the present invention is particularly useful as a water conduit for domestic and industrial uses.

### BRIEF DESCRIPTION OF THE DRAWINGS

The novel features which are characteristic of the present invention are set forth with particularity in the appended claims. The invention itself, however, both as to structure and method of use will best be understood from the accompanying description of a specific embodiment when read in connection with the Drawings in which:

FIG. 1 is a perspective view of one embodiment of a flexible hose according to the present invention;

FIG. 2 is a perspective view of an alternative embodiment of a flexible hose according to the present invention; and

FIG. 3 is a sectional view of a preferred embodiment of a flexible hose according to the present invention.

### DETAILED DESCRIPTION OF THE PREFERRED EMBODIMENT

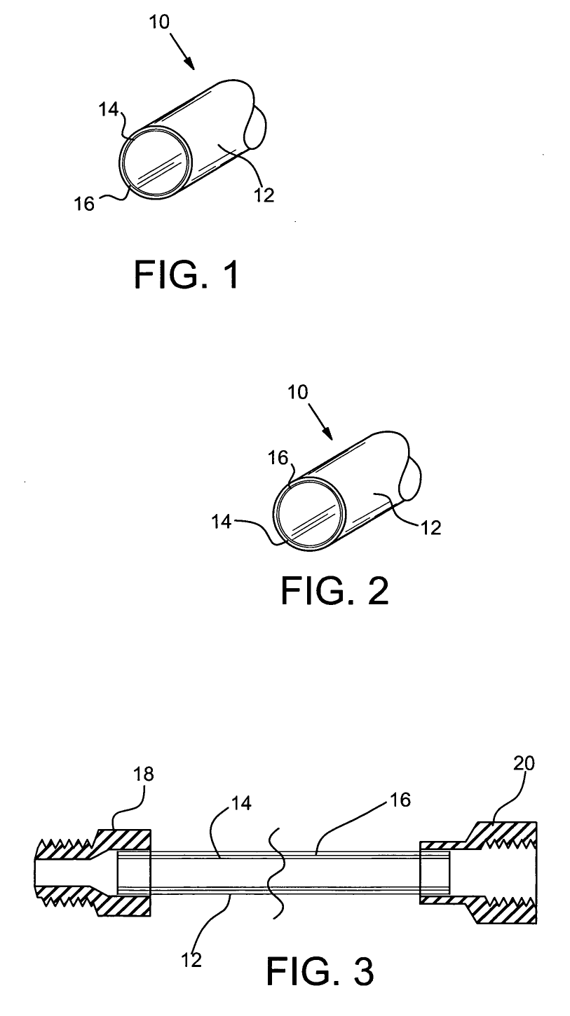

Referring now to the Drawings, and particularly FIGS. 1 and 2, there is shown generally at 10 a flexible hose 12 according to the present invention, comprising a non-woven spun bonded fibrous polyolefin tube 14, and a layer of a liquid impervious polymer 16 adhered to a major surface of the polyolefin tube 14. As is readily apparent from the Drawings, the layer of liquid impervious polymer 16 may be on the interior or the exterior of the polyolefin tube 14. In a preferred embodiment, male and female hose couplings 18 and 20, respectively, are attached by conventional means to the ends of a length of the inventive flexible hose 12.

The non-woven spun bonded fibrous polyolefin web material from which the filament reinforced polyolefin tube 14 of the inventive flexible hose weight fiber forming polymers such as, for example, polyethylene, polypropylene, polybutene may be made is prepared by conventional processes from strands of high molecular, polyisobutylene, polybutadiene, and blends, derivatives, and copolymers thereof. A particularly preferred non-woven spun bonded fibrous polyolefin web material is a linear polyethylene product which may be obtained from E. I. duPont de Nemours & Co. under the product designation “TYVBK.” The non-woven spun bonded fibrous polyolefin according to the present invention is highly flexible and has excellent dimensional stability, but is also highly porous to liquids and gases.

A layer of a liquid impervious polymer 16 is adhered to a major surface of the non-woven spun bonded fibrous polyolefin tube 14. The polymer may be any conventional, flexible, liquid impervious polymer such as, for example, low, medium, or high density polyethylene, polyurethane, polypropylene, polybutene, polyisoprene, copolymers of ethylene and/or propylene with one or more copolymerizable monomers such as, for example, vinyl acetate, acrylic acid, butadiene, isoprene, and the like, as well as blends and copolymers thereof.

The layer of liquid impervious polymer may be adhered to the non-woven spun bonded fibrous polyolefin web by any conventional method such as, for example, curtain coating, doctor blading, spraying, or laminating, wherein a web of the liquid impervious polymer is contacted to the non-woven spun bonded fibrous polyolefin web, and thereafter adhered thereto by heat and pressure or by curing. The thickness of the liquid impervious polymer layer may vary over wide limits from about 0.0001 inch to about 0.05 inch. One ordinarily skilled in the art will appreciate that the thickness of the liquid impervious polymer layer need only be so great as to insure that the ultimately produced flexible hose product is substantially impervious to liquid (generally, water), yet not so great as to substantially diminish the flexibility of the product.

Conveniently, the non-woven spun bonded fibrous polyolefin web bearing the liquid impervious polymer layer may be slit into elongated strips having opposite, parallel, coextensive first and second edges. Alternatively, the non-woven spun bonded fibrous polyolefm web may be slit into elongated strips before the liquid impervious polymer is applied thereto. The first and second edges are joined by conventional means to form an elongated flexible, liquid impervious hose. The first and second edges may be joined together in an elongate fashion, or the edges may be joined together in a spiral fashion. For example, the edges may be joined by merely rolling the elongated coated strip into a generally cylindrical shape, overlapping one of the edges onto the other edge, and heat sealing the elongated seam to form a tube. Alternatively, the edges may be overlapped, and the polymer cured by heat and pressure or by exposure to radiant energy. In yet another alternative embodiment, the edges may be sewn or stitched together. The required amount of overlap, and therefore the heat sealed area disposed inwardly from the first and second edges, can readily be determined by one ordinarily skilled in the art, depending upon the liquid pressure to be experienced by the ultimately-produced hose, the tenacity of the bond between the first and second edges which is in part dependent upon the materials used for the non-woven spun bonded fibrous polyolefin and liquid impervious polymer layers, and the like. Preferably, the amount of overlap is at least about 1/4 inch.

As will be readily apparent to one ordinarily skilled in the art, the liquid impervious polymer layer may be on the interior surface or the exterior surface of the ultimately-produced flexible hose. Preferably, the liquid impervious polymer layer is formed on the interior surface of the flexible hose, to protect the liquid impervious layer from abrasion.

In a preferred embodiment of the invention, hose couplings may be attached at opposite ends of the flexible hose. Hose couplings, such as conventional threaded male and female garden hose couplings, are well-known in the art. Likewise, methods for attaching and sealing the joints between the hose end and the hose couplings are well-known.

The highly flexible, liquid impervious hose, and process for preparing same, are generally disclosed hereinabove in terms of their broadest application to the practice of the present invention. Occasionally, the materials of construction and process description may not be precisely applicable to each operable flexible hose construction and process included within the contemplated scope of the invention. Those instances where this occurs, however, will be readily recognized by those ordinarily skilled in the art. In all such cases, the inventive flexible hose may be successfully prepared by conventional modifications to the disclosed materials of construction and process.

The invention is more easily comprehended by reference to specific embodiments recited hereinabove which are representative of the invention. It must be understood, however, that the specific embodiments are provided only for the purpose of illustration, and that the invention may be practiced otherwise than as specifically illustrated without departing from its spirit and scope. For example, when the term “web” is used herein, it is meant to include an elongated strip of material as well as a broad continuous sheet of material.

What is claimed is:

1. A flexible hose, comprising:
a non-woven spun bonded fibrous polyolefm tube; and
a layer of a liquid impervious polymer adhered to a major surface of the tube.

2. The flexible hose according to claim 1, wherein the fibrous polyolefin tube comprises polyethylene, polypropylene, polybutene, polyisobutylene, polybutadiene, or a blend, derivative, or copolymer thereof.

3. The flexible hose according to claim 2, wherein the fibrous polymer tube comprises linear polyethylene.

4. The flexible hose according to claim 1, wherein the liquid impervious polymer comprises low, medium, or high density polyethylene, polyurethane, polypropylene, polybutene, polyisoprene, or a copolymer of ethylene and/or propylene with one or more copolymerizable monomers of vinyl acetate, acrylic acid, butadiene, or isoprene, or a blend or copolymer thereof.

5. The flexible hose according to claim 1, wherein the thickness of the liquid impervious polymer adhered to the fibrous polyolefin tube ranges from about 0.0001 inch to about 0.05 inch.

6. The flexible hose according to claim 1, wherein the liquid impervious polymer is adhered to the outside major surface of the fibrous polymer tube.

7. The flexible hose according to claim 1, wherein the liquid impervious polymer is adhered to the inside major surface of the fibrous polymer tube.

8. The flexible hose according to claim 1, further comprising male and female hose couplings attached to opposite ends of the flexible hose.

9. A flexible hose, comprising:
a linear polyethylene non-woven spun bonded fibrous polyolefm tube; and
a layer of a liquid impervious polymer, comprising low, medium, or high density polyethylene or polyurethane, adhered to a major surface of the tube, said layer having a thickness ranging from about 0.0001 inch to about 0.05 inch.

10. The flexible hose according to claim 9, wherein the liquid impervious polymer is adhered to the outside major surface of the fibrous polymer tube.

11. The flexible hose according to claim 9, wherein the liquid impervious polymer is adhered to the inside major surface of the fibrous polymer tube.

12. The flexible hose according to claim 9, further comprising male and female hose couplings attached to opposite ends of the flexible hose.
